(19) United States
(12) Patent Application Publication
(10) Pub. No.: US 2011/0164005 A1
(43) Pub. Date: Jul. 7, 2011

(54) DISPLAY DEVICE

(75) Inventor: Hideki Miyata, Osaka (JP)

(73) Assignee: SHARP KABUSHIKI KAISHA, Osaka (JP)

(21) Appl. No.: 13/063,153

(22) PCT Filed: Jul. 6, 2009
(86) PCT No.: PCT/JP2009/062313

§ 371 Date: Mar. 9, 2011

(30) Foreign Application Priority Data
Sep. 17, 2008 (JP) 2008-238337

(51) Int. Cl. G09G 5/00

(52) U.S. Cl. 345/204

(57) ABSTRACT

Provided is a liquid crystal display device (1) including a liquid crystal panel (display unit) (2) having a plurality of pixels (P) for displaying information on the liquid crystal panel (2). The liquid crystal display device (1) includes: a bezel (14) for housing the liquid crystal panel (2); a plurality of source drivers (23-1 to 23-9) for driving the plurality of pixels (P); a plurality of printed circuit boards (10) arranged inside the bezel (14) and respectively connected to at least one of the source drivers (23-1 to 23-9); and a flexible printed circuit board (28) pulled out of the bezel (14) and connected between two adjacent printed circuit boards (10).

### TECHNICAL FIELD

The present invention relates to a display device that includes a display unit equipped with a plurality of pixels and that displays information such as characters and images on the display unit.

### BACKGROUND ART

In recent years, a liquid crystal display device, for example, has widely been in use for liquid crystal televisions, monitors, and cell phones, as a flat panel display which is thinner and lighter than conventional cathode-ray tube displays. In such liquid crystal display device, a liquid crystal panel having a plurality of pixels is used as a display unit that displays information such as characters and images. In a liquid crystal display device, a display operation is performed as a voltage signal corresponding to a gradation value of the information to be displayed is supplied to each of the plurality of pixels, and the information is thereby displayed on a display of the liquid crystal panel.

As discussed in Patent Document 1 below, for example, a conventional liquid crystal display device is known to include an active matrix substrate, which is used for a liquid crystal panel as the aforementioned display unit. In the active matrix substrate, a plurality of source wirings (data wirings) and a plurality of gate wirings (scan wirings) are arranged in a matrix, and pixels having switching elements such as TFTs (Thin Film Transistor) near intersections of the source wirings and the gate wirings are arranged in a matrix form. In such a conventional liquid crystal display device, source drivers and gate drivers were connected to the source wirings and the gate wirings, and the source drivers and gate drivers respectively outputted the aforementioned voltage signals (data signals) according to the information and the gate signals to the corresponding source wirings and the gate wirings, respectively, thereby properly driving the plurality of the pixels to display the information.

### RELATED ART DOCUMENTS

### Patent Documents

Patent Document 1: Japanese Patent Application Laid-Open Publication No. 2004-61670

### SUMMARY OF THE INVENTION

### Problems to be Solved by the Invention

However, in the above-described conventional liquid crystal display device, increasing the size of the liquid crystal panel (display unit) for a larger screen required an installation of a plurality of drivers that drive pixels, that is, source drivers and gate drivers, thereby creating a potential problem of inappropriate connection between the plurality of the source drivers.

Specifically, in conventional liquid crystal display devices, when the size of the liquid crystal panel was increased for a larger screen, an installation of a plurality of source drivers was required depending on the size of the screen. Also, each of the source drivers was mounted on, for example, a flexible printed circuit board or on an active matrix substrate of the liquid crystal panel and was further connected to a control unit that controls the driving of each of the source drivers, through a printed circuit board provided inside a bezel that houses the liquid crystal panel.

In the above-mentioned printed circuit board, the size thereof is limited to approximately 40 cm or smaller to avoid problems such as distortion by heat. Therefore, when an increased number of source drivers are installed for a larger liquid crystal panel, a greater number of printed circuit boards need to be installed as well.

Also, in the conventional liquid crystal display device, when a plurality of printed circuit boards were installed to accommodate a greater number of the source drivers installed, a connecting member was provided inside the bezel to connect two adjacent printed circuit boards to each other. Further, in the conventional liquid crystal display device, after the two adjacent printed circuit boards were connected to each other by the above-mentioned connecting member, the printed circuit boards and the connecting member were built into the bezel. Therefore, in the conventional liquid crystal display device, damages such as wire breakage might occur to the connecting member when the aforementioned printed circuit boards and the connecting member are built into the bezel. This could lead to a problem that the printed circuit boards cannot be connected to each other and a further problem that the source drivers cannot be connected to each other either. Also, in the conventional liquid crystal display device, since the printed circuit boards and the connecting member were installed inside the bezel as described above, whether or not the connecting member and each of the printed circuit boards were properly interconnected is difficult to verify.

The present invention was devised in consideration of the above-described problems, and is aiming at providing a display device that is capable of properly connecting a plurality of drivers together when the size of a display unit needs to be increased for a larger screen.

### Means for Solving the Problems

To achieve the above objectives, a display device according to the present invention is configured to include a display unit provided with a plurality of pixels to display information on the display unit; and the display device further includes a bezel that houses the display unit, a plurality of drivers that drive the plurality of pixels, a plurality of printed circuit boards provided inside the bezel and respectively connected to at least one of the drivers, and a flexible printed circuit board that is pulled out of the bezel and is connected between two adjacent printed circuit boards.

In the display device configured as described above, the plurality of the printed circuit boards, to each of which at least one driver is respectively connected, are provided inside the bezel. Also, in the display device, the flexible printed circuit board is pulled out of the bezel and is connected to the two adjacent printed circuit boards. As a result, unlike the conventional examples, it is possible to configure a display device that is capable of properly connecting a plurality of drivers even when the size of the display unit needs to be increased for a larger screen.

Also, it is preferred that the display device be equipped with a chassis to be attached to the bezel and that the flexible printed circuit board be fixed to an outer surface of the chassis.

In the above case, it is possible to stabilize the condition of the attachment of the flexible printed circuit board and also to secure the connection with the two printed circuit boards. As a result, it also becomes possible to connect the plurality of the drivers to each other in a more appropriate condition.

Also, in the above display device, it is preferred that the flexible printed circuit board be provided with a ground wire and that the ground wire be electrically connected to the chassis.

In the above case, it is possible to easily ground the flexible printed circuit board and also each of the two printed circuit boards.

Also, in the above display device, it is preferred that the flexible printed circuit board be provided with a connector that is electrically connected to the printed circuit boards and also that a slit be formed in the flexible printed circuit board between the connector and a fixture to the chassis.

In the above case, if a twisting occurs between the connector and the fixture in the flexible printed circuit board, the twisting can be absorbed by the slit, thereby increasing the structural strength of the flexible printed circuit board.

Also, in the above display device, the display unit includes a liquid crystal panel, and the chassis may also be a case for housing a light source that emits the illumination light in an illumination device that irradiates the liquid crystal panel with the illumination light.

In the above case, when the size of the liquid crystal panel needs to be increased for a larger screen, it is possible to configure a liquid crystal display device in which a plurality of drivers are properly connected.

### EFFECTS OF THE INVENTION

According to the present invention, it is possible to provide a display device capable of properly connecting a plurality of drivers therein when the size of a display unit needs to be increased for a larger screen.

### BRIEF DESCRIPTION OF THE DRAWINGS

FIG. 1 is a schematic cross-sectional view explaining a liquid crystal display device according to Embodiment 1 of the present invention.

FIG. 2 is a diagram explaining a configuration of a main portion of a liquid crystal panel shown in FIG. 1.

FIG. 3 is a plan view showing a printed circuit board and a flexible printed circuit board shown in FIG. 1.

FIG. 4 is an enlarged plan view showing the printed circuit board and the flexible printed circuit board.

FIG. 5 is an enlarged plan view showing a configuration of a main portion of the flexible printed circuit board shown in FIG. 4.

FIG. 6 is an enlarged plan view showing a printed circuit board and a flexible printed circuit board of a liquid crystal display device according to Embodiment 2 of the present invention.

FIG. 7 is an enlarged plan view showing a configuration of a main portion of the flexible printed circuit board shown in FIG. 6.

### DETAILED DESCRIPTION OF EMBODIMENTS

Preferred embodiments of a display device of the present invention are described below with reference to figures. In the following description, a case in which the present invention is applied to a transmissive liquid crystal display device is illustrated as an example. Additionally, the size of components in each of the figures does not precisely represent the actual size of the components or the proportion of the size between each of the components.

### Embodiment 1

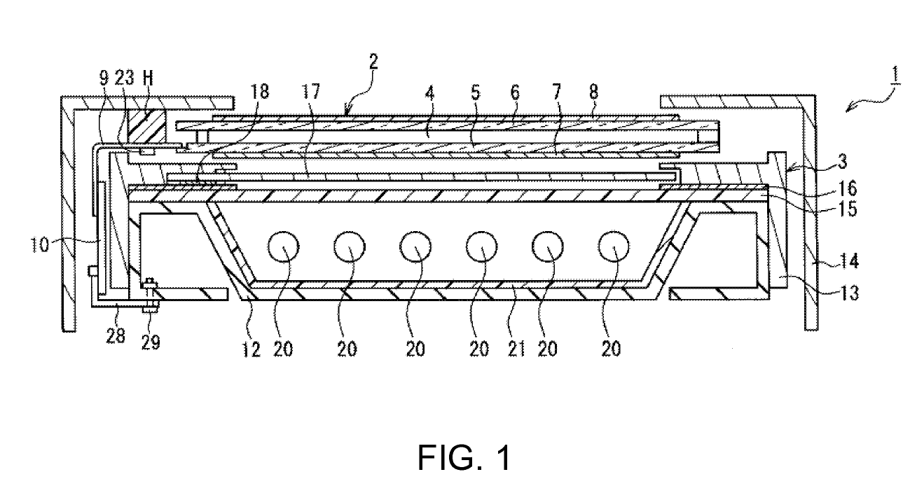

FIG. 1 is a schematic cross-sectional view explaining a liquid crystal display device according to Embodiment 1 of the present invention. As shown in the figure, a liquid crystal display device 1 of the present embodiment includes a liquid crystal panel 2, which is disposed therein as a display unit whose upper side in the figure is a viewer side (display surface side), and a illumination device 3, which is arranged on a non-display surface side (lower side in the figure) of the liquid crystal panel 2 and irradiates the liquid crystal panel 2 with illumination light.

The liquid crystal panel 2 is equipped with a liquid crystal layer 4, an active matrix substrate 5 and a color filter substrate 6 sandwiching the liquid crystal layer 4, and polarizing plates 7 and 8 provided on outer surfaces of the active matrix substrate 5 and the color filter substrate 6, respectively. Additionally, the liquid crystal panel 2 includes flexible printed circuit boards 9 and also printed circuit boards 10 connected to the flexible printed circuit board 9. Also, as described later, the flexible printed circuit boards 9 and the printed circuit boards 10 are respectively provided in plurality according to the number of source drivers 23 provided in plurality.

Additionally, the flexible printed circuit board 9 is a so called SOF (System On Film) and includes a source driver 23 mounted thereon. The source driver 23 functions as a driver that drives the liquid crystal layer 4 on a pixel by pixel basis. Here, one side of the flexible printed circuit board 9 (upper surface in FIG. 1), which is opposite to the surface on which the source driver is mounted, abuts against a heat dissipating sheet H made of, for example, synthetic resin so that the heat generated from the source driver 23 is conducted to a bezel, which is described below, through the heat dissipating sheet H and then is released outside.

Additionally, in a plurality of the printed circuit boards 10, two adjacent printed circuit boards 10 are connected to each other via a flexible printed circuit board 28 (which is described later in detail). Further, the printed circuit boards 10 are electrically connected to a panel control unit, which is described later, so that the panel control unit controls the driving of the source driver 23. And, in the liquid crystal panel 2, the polarization of the illumination light entering through the polarizing plate 7 is modulated by the liquid crystal layer 4, and the amount of light passing through the polarizing plate 8 is controlled. As a result, a desired image is displayed.

Here, for the liquid crystal panel 2, a liquid crystal mode and a structure of pixels can be set as desired. Also, a drive mode for the liquid crystal panel 2 can be set as desired as well. In other words, any liquid crystal panel capable of displaying information may be used for the liquid crystal panel 2. Therefore, a detailed structure of the liquid crystal panel 2 is not shown in FIG. 1, and the description thereof is also omitted herein.

The illumination device 3 includes a chassis 12, which has a bottom and is open on an upper side thereof in the figure (side facing the liquid crystal panel 2); and a frame 13, which has a frame-like form and is installed on the chassis 12 on a side facing the liquid crystal panel 2. Also, both the chassis 12 and the frame 13 are composed of a metal or a synthetic resin and are held by a bezel 14 having an L-shaped cross-section, with the liquid crystal panel 2 being disposed above the frame 13. Specifically, the chassis 12 is a case for the illumination device 3 for housing cold cathode fluorescent lamps, which are the light source and are described later. Also, the bezel 14 is for housing the liquid crystal panel 2 and is attached to the frame 13 and the chassis 12 while holding the liquid crystal panel 2 with the frame 13. The bezel 14 is also called a plastic chassis. And, the illumination device 3 is attached to the liquid crystal panel 2 to together constitute the liquid crystal display device 1, which is a transmissive liquid crystal display device in which the illumination light from the illumination device 3 enters the liquid crystal panel 2.

Additionally, the illumination device 3 includes a diffusion panel 15 disposed so as to cover the opening of the chassis 12; an optical sheet 17 disposed over the diffuser panel 15 to face the liquid crystal panel 2; and a reflective sheet 21 disposed on an inner surface of the chassis 12. Also, in the illumination device 3, a plurality of cold cathode fluorescent lamps 20, six thereof, for example, are disposed inside the chassis 12 under the liquid crystal panel 2 to constitute the illumination device 3, which is a direct illumination type. Further, in the illumination device 3, the light from the cold cathode fluorescent lamps 20 is emitted as the illumination light from a light-emitting surface, a surface facing the liquid crystal panel 2, of the illumination device 3.

Here, the above description describes a configuration that employs the illumination device 3, which is a direct illumination type. However, the present embodiment is not limited to that configuration, and an edge light type illumination device having a light guide plate may also be used. Additionally, illumination devices having other light sources than the cold cathode fluorescent lamps, such as hot cathode fluorescent lamps, LEDs, and the like may be used as well.

The diffusion panel 15 is composed of a synthetic resin or glass material of a rectangular shape with a thickness of approximately 2 mm, for example, and diffuses and projects the light from the cold cathode fluorescent lamps 20 towards the optical sheet 17. Additionally, the diffusion panel 15, whose four sides resting on a frame-shaped surface provided on an upper side of the chassis 12, is built into the illumination device 3 while being held between the aforementioned surface of the chassis 12 and the inner surface of the frame 13 through an elastically deformable pressure member 16. Further, in the diffusion panel 15, an approximate center portion thereof is supported by a transparent support member (not shown) disposed inside the chassis 12, thereby preventing the diffusion panel 15 from bending towards inside the chassis 12.

Additionally, the diffusion panel 15 is held to be movable between the chassis 12 and the pressure member 16. Therefore, if the diffusion panel 15 is elastically (plastically) deformed by the heat generated from the cold cathode fluorescent lamps 20 or by the increased temperature inside the chassis 12, such elastic (plastic) deformation of the diffusion panel 15 is absorbed by the elastic deformation of the pressure member 16, which minimizes a reduction in the diffusibility of the light from the cold cathode fluorescent lamps 20. Also, it is preferred that the diffusion panel 15 made of a glass material be used, which is more heat-resistant than that made of synthetic resin. That is, with a diffusion panel 15 made of glass, heat-induced problems such as bend, yellowing, and deformation are less likely to occur.

The optical sheet 17 is configured to include a light collection sheet composed of a synthetic resin film with a thickness of approximately 0.5 mm, for example, so that the luminance of the illumination light projected to the liquid crystal panel 2 can be increased. Additionally, for the optical sheet 17, commonly-known optical sheet materials, such as prism sheet, diffusion sheet, polarizing sheet, and the like, are layered as needed to improve the display quality on the display surface of the liquid crystal panel 2. The optical sheet 17 is configured so as to transform the light projected from the diffusion panel 15 into a planar light having a uniform, predetermined luminance (for example, 10000 cd/m²) or higher, and is also configured to project the light as the illumination light towards the liquid crystal panel 2. Here, in addition to the description above, optical members such as a diffusion sheet may also be layered as appropriate over the liquid crystal panel 2 (on the display surface side), for example, for adjustment of the viewing angle of the liquid crystal panel 2.

Additionally, in the optical sheet 17, a projection extending to the left in FIG. 1 is formed in the center of the left end side thereof, which is shown as the left end side in FIG. 1 and which becomes the top end side when the liquid crystal display device 1 is actually used, for example. And, in the optical sheet 17, only the projection is held between the inner side of the frame 13 and the pressure member 16 through an elastic material 18 so that the optical sheet 17 is extendable and shrinkable within the illumination device 3. This enables the optical sheet 17 to be freely and elastically deformed around the projection when the heat generated from the cold cathode fluorescent lamps 20 and such cause an elastic (plastic) deformation in the optical sheet, thereby minimizing the formations of wrinkles and bends thereon. As a result, in the liquid crystal display device 1, it is possible to minimize the occurrence of problems that decrease the display quality on the display surface of the liquid crystal panel 2, such as uneven brightness, caused by a deflection of the optical sheet 17.

Each of the cold cathode fluorescent lamps 20 is a straight tube fluorescent lamp, having on both ends an electrode unit (not shown), which is supported outside the chassis 12. Also, each of the cold cathode fluorescent lamps 20 is a narrow fluorescent tube, which is approximately 3.0 to 4.0 mm in diameter and is superior in light emission efficiency, and is kept inside the chassis 12 while maintaining a predetermined distance to the diffusion panel 15 and to the reflective sheet 21, respectively, by a light source retainer not shown in the figure. Further, the cold cathode fluorescent lamps 20 are arranged so that the longitudinal direction thereof is parallel to the direction perpendicular to the direction of the action of gravity. As a result, mercury (vapor) enclosed inside the cold cathode fluorescent lamps 20 is prevented from gathering in one longitudinal end thereof due to the action of gravity, thereby substantially prolonging the life of the lamp.

The reflective sheet 21 is constituted of a highly-reflective thin metal film such as aluminum or silver with a thickness of approximately 0.2 to 0.5 mm, for example, and is configured so as to function as a reflective panel that reflects the light from the cold cathode fluorescent lamps 20 towards the diffusion panel 15. Therefore, in the illumination device 3, the light emitted by the cold cathode fluorescent lamps 20 is efficiently reflected to the diffusion panel 15, thereby improving the light utilization efficiency and also the luminance of the light at the diffusion panel 15. Here, in addition to the above description, it is also possible to use a reflective sheet material made of a synthetic resin in place of the thin metal film, or to paint an inner surface of the chassis 12 in a highly-reflective color such as white to function as a reflective panel.

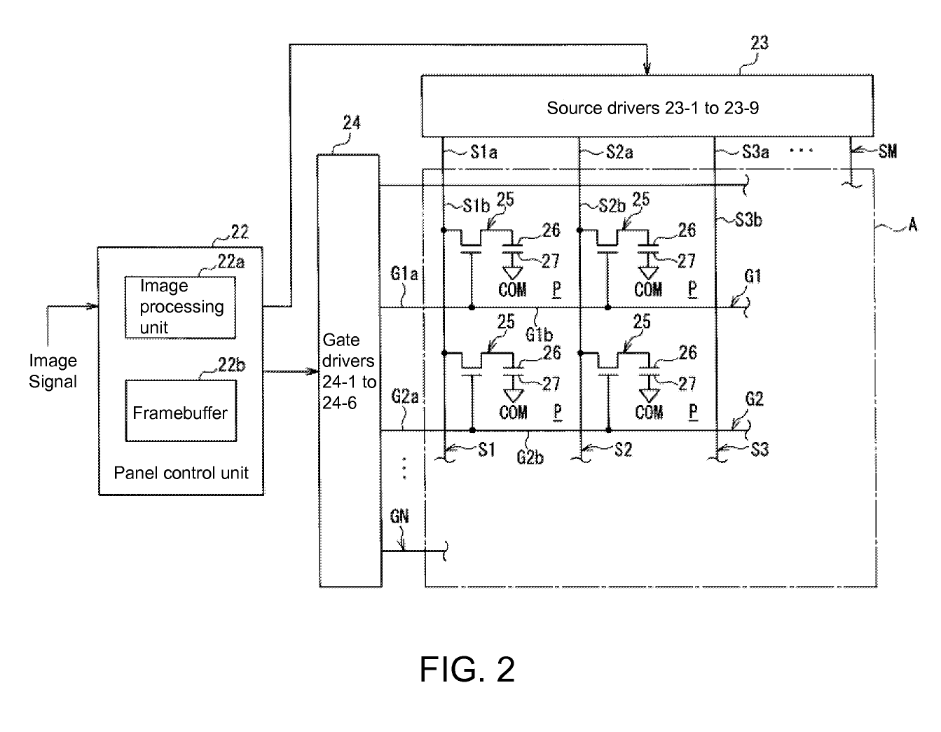

Next, a liquid crystal panel 2 is specifically described below in reference to FIG. 2.

FIG. 2 is a diagram explaining a configuration of a main portion of a liquid crystal panel shown in FIG. 1.

In FIG. 2, a liquid crystal display panel 1 (see FIG. 1) includes a panel control unit 22, which controls the driving of a liquid crystal panel 2 (see FIG. 1) that functions as the aforementioned display unit displaying information such as characters and images; a plurality of source drivers, nine source drivers, for example, such as 23-1, 23-2, . . . , 23-8, 23-9 (hereinafter collectively referred to as “23”), that operate according to an instructions signal sent from the panel control unit 22; and a plurality of gate drivers, six gate drivers, for example, such as 24-1, 24-2, . . . , 24-5, 24-6 (hereinafter collectively referred to as “24”), that also operate according to an instructions signal sent from the panel control unit 22.

The panel control unit 22 is configured so that image signals from outside the liquid crystal display device 1 are inputted thereto. Also, the panel control unit 22 includes an image processing unit 22a, which performs a predetermined image processing and generates instructions signals to be sent respectively to the source drivers 23 and the gate drivers 24; and also a framebuffer 22b, which is capable of storing display data for one frame included in the inputted image signals. The panel control unit 22 controls the driving of the source drivers 23 and the gate drivers 24 according to the inputted image signals, and the information corresponding to the image signals is thereby displayed on the liquid crystal panel 2.

The source drivers 23 are mounted to the flexible printed circuit boards 9, as described above. Similarly, the gate drivers 24 are mounted on flexible printed circuit boards that are described later. Additionally, these source drivers 23 and gate drivers 24 are drive circuits that drive a plurality of pixels P on a pixel by pixel basis, which are provided within an effective display area A of the liquid crystal panel 2. To the source drivers 23 and the gate drivers 24, a plurality of source wirings S1 to SM (“M” denotes 9 or a greater integer; hereinafter collectively referred to as “S”) and also a plurality of gate wirings G1 to GN (“N” denotes 6 or a greater integer; hereinafter collectively referred to as “N”) are connected, respectively.

Additionally, the source wirings S and the gate wirings G are arranged in a matrix at least within the effective display area A, and areas of the plurality of the pixels P are formed respectively in areas partitioned in a matrix. Specifically, as illustrated in FIG. 2, the source wirings S include source wiring main segments S1b, S2b, S3b, . . . , which are arranged parallel to the vertical direction of the liquid crystal panel 2; and also connecting segments S1a, S2a, S3a, . . . that connect the source wiring main segments S1b, S2b, S3b, . . . , to the source drivers 23 with a shortest possible distance inbetween. Similarly, the gate wirings G include gate wiring main segments G1b, G2b, . . . , arranged parallel to the horizontal direction of the liquid crystal panel 2; and also connecting segments G1a, G2a, . . . , connecting the gate wiring main segments G1b, G2b, . . . , to the gate drivers 24 with a shortest possible distance inbetween.

Also, the plurality of pixels P include pixels in red, green, and blue. The pixels in red, green, and blue are arranged parallel to the gate wiring main segments G1b, g2b, . . . , of each of the gate wirings G, sequentially, for example in this order.

Additionally, a gate of a switching element 25 provided in each of the pixels P is connected to the gate wiring main segment G1b, g2b, . . . . A source of the switching element 25 is connected to the source wiring main segment S1b, S2b, S3b, . . . . Additionally, a drain of each of the switching elements 25 is connected to a pixel electrode 26 provided in each of the pixels P. Also, each of the pixels P is configured so that a common electrode 27 therein faces against the pixel electrode 26 with a liquid crystal layer 4 (see FIG. 1) provided in the liquid crystal panel 2 being sandwiched therebetween. And, based on the instructions signals sent from the image processing unit 22a, the gate drivers 24 sequentially output to the gate wirings G1 to GN a scan signal that turns on the gate of the corresponding switching elements 25. On the other hand, based on the instructions signals sent from the image processing unit 22a, the source drivers 23 output to the corresponding source wirings S1 to SM a voltage signal (gradation voltage) according to the luminance (gradation) of a display image.

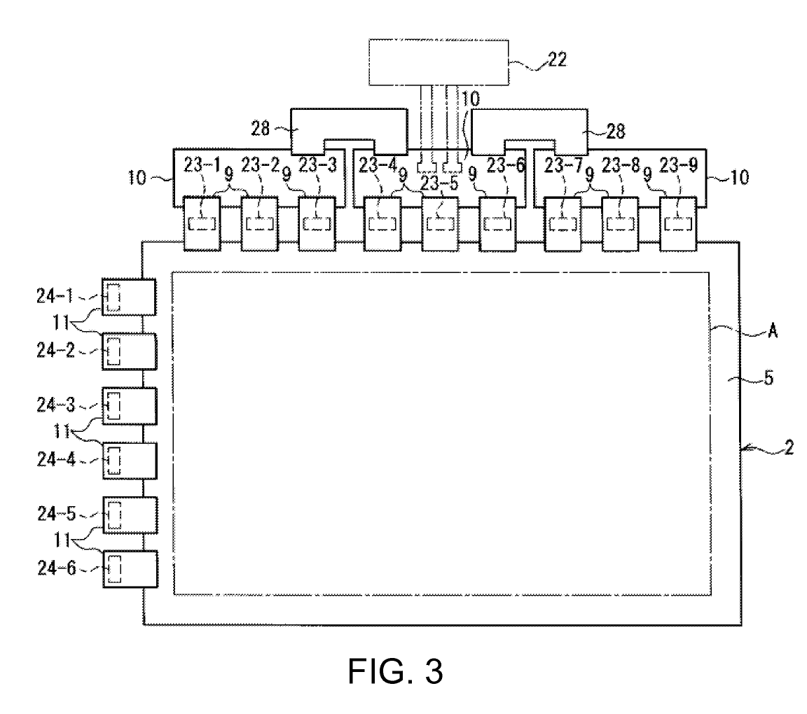

Here, a flexible printed circuit board 9, a printed circuit board 10, and a flexible printed circuit board 28 are specifically described as follows with reference to FIGS. 3 to 5.

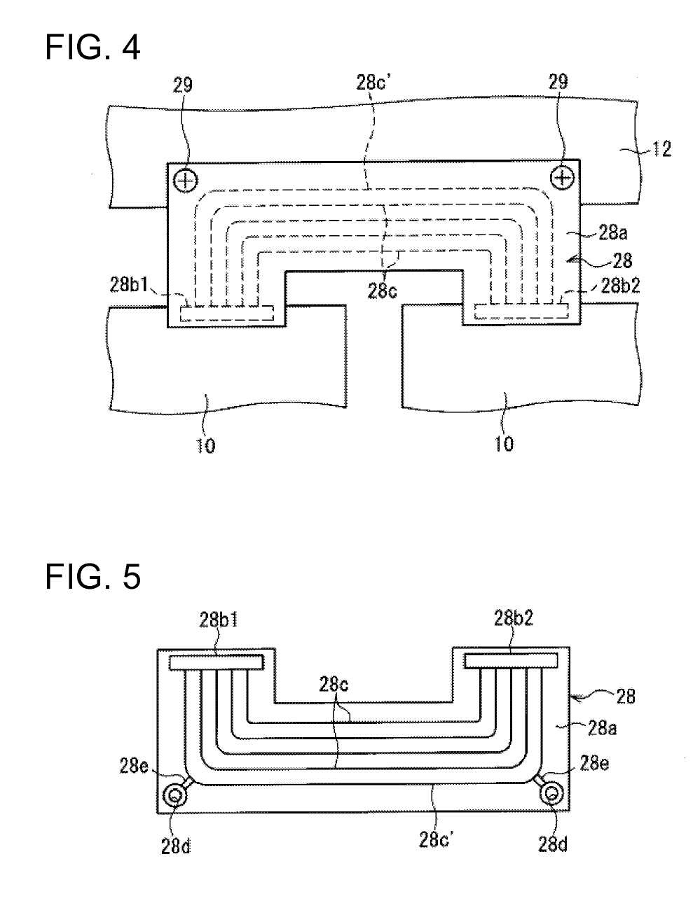

FIG. 3 is a plan view showing printed circuit boards and flexible printed circuit boards shown in FIG. 1. FIG. 4 is an enlarged plan view showing the printed circuit boards and the flexible printed circuit board. FIG. 5 is an enlarged plan view showing a configuration of a main portion of the flexible printed circuit board shown in FIG. 4.

First, a connection condition between an active matrix substrate 5, source drivers 23, and gate drivers 24 is specifically explained as follows with reference to FIG. 3.

As shown in FIG. 3, nine source drivers 23-1 to 23-9 are respectively mounted on nine flexible printed circuit boards (SOF) 9 on a liquid crystal panel 2. One end of each of the flexible printed circuit boards 9 is connected to source wirings S on the active matrix substrate 5 outside an effective display area A. Additionally, the source drivers 23-1 to 23-9 are respectively connected to the same number of the source wirings S, which means M/9 source wirings S.

Additionally, the other end of each of the flexible printed circuit boards 9 is connected to a printed circuit board 10. Specifically, as illustrated in FIG. 3, three printed circuit boards 10 are provided to the liquid crystal panel 2, and each of the printed circuit boards 10 is connected to three flexible printed circuit boards 9. Also, a flexible printed circuit board 28 is provided between two adjacent printed circuit boards 10 to connect the two printed circuit boards 10 to each other. In other words, two flexible printed circuit boards 28 are provided for three printed circuit boards 10, and the nine source drivers 23-1 to 23-9 are sequentially connected together via the printed circuit boards 10 and the flexible printed circuit boards 28 so as to function as a single source driver. Additionally, a panel control unit 22 is connected to a printed circuit board 10 in the middle, and instructions signals corresponding to the information to be displayed on the display unit of the liquid crystal panel 2 are inputted from an image processing unit 22a of the panel control unit 22 to each of the source drivers 23-1 to 23-9. And, each of the source drivers 23-1 to 23-9 outputs the aforementioned voltage signals to the corresponding source wirings S.

Also, six source drivers 24-1 to 24-6 are respectively mounted on six flexible printed circuit boards (SOF) 11 on the liquid crystal panel 2. One end of each of the flexible printed circuit boards 11 is connected to gate wirings G on the active matrix substrate 5 outside the effective display area A. And, the gate drivers 24-1 to 24-6 are respectively connected to the same number of the gate wirings G, which means N/6 gate wirings G. Further, each of the gate drivers 24-1 to 24-6 is connected to the panel control unit 22 via a wiring (not shown) provided on the corresponding flexible printed circuit board 11 and the active matrix substrate 5. And, each of the gate drivers 24-1 to 24-6 receives the instructions signals from the image processing unit 22a and outputs the scan signals to the corresponding gate wiring G.

Additionally, in the liquid crystal panel 2, the flexible printed circuit boards 9 and 11 are bent against the active matrix substrate 5, and the flexible printed circuit boards 9 and 11, and the printed circuit boards 10 are thereby arranged inside a bezel 14, as shown in FIG. 1. Also, the flexible printed circuit board 28 is pulled out of the bezel 14 as shown in FIG. 1 and is fixed onto the outer surface of the chassis 12 with a screw 29.

The flexible printed circuit board 28 is specifically explained as follows with reference to FIGS. 4 and 5.

As shown in FIGS. 4 and 5, a flexible printed circuit board 28 includes a substrate body 28a that is bendable; two connectors 28b1 and 28b2 provided on the substrate body 28a; and a plurality of wirings 28c formed in a predetermined pattern on the substrate body 28a so as to connect the connectors 28b1 and 28b2 to each other. The connectors 28b1 and 28b2 are configured to be electrically connected to two adjacent printed circuit boards 10. In other words, the connectors 28b1 and 28b2 are configured so as to be linked to a connector receptacle (not shown) provided on each of the printed circuit boards 10, thereby electrically interconnecting the source drivers 23 connected to the respective printed circuit boards 10.

Also, on the flexible printed circuit board 28, a ground wire 28c′ is formed between the connector 28b1 and the connector 28b2 and is configured to be electrically connected to the chassis 12. In other words, two holes 28d are provided on the flexible printed circuit board 28, and a connecting portion 28e connected to the ground wire 28c′ is formed inside and around each of the holes 28d. And, when the screw 29 is inserted through the hole 28d and the flexible printed circuit board 28 is therefore fixed to the chassis 12 with the screw 29, the ground wire 28c′ is electrically connected to the chassis 12 via the connecting portion 28e and the screw 29, and the flexible printed circuit board 28 and each of the two printed circuit boards 10 are thereby grounded. Here, the hole 28d and the screw 29 constitute a fixing portion that fixes the flexible printed circuit board 28 to the chassis 12.

In the liquid crystal display device 1 according to the above-described configuration of the present embodiment, three printed circuit boards 10 to each of which three source drivers (drivers) 23 are respectively connected are provided inside a bezel 14. Also, in the liquid crystal display device 1 of the present embodiment, a flexible printed circuit board 28 is pulled out of the bezel 14 to interconnect two adjacent printed circuit boards 10. Therefore, in the liquid crystal display device 1 of the present embodiment, unlike the aforementioned conventional examples, it is possible to prevent damages such as wire breakage from occurring at the flexible printed circuit board 28 connecting the two printed circuit boards 10, when the printed circuit boards 10 are built into the bezel. This further prevents poor connections between the printed circuit boards 10 and also between the source drivers 23.

Also, in the liquid crystal display device 1 of the present embodiment, the flexible printed circuit board 28 is pulled out of the bezel 14, thereby making it possible to confirm whether or not the flexible printed circuit board 28 and each of the printed circuit boards 10 are properly connected.

As a result, according to the present embodiment, unlike the conventional examples, it is possible to configure a liquid crystal display device 1 capable of properly connecting a plurality of the source drivers 23 when the size of the liquid crystal panel (display unit) is increased for a larger screen.

Additionally, in the liquid crystal display device 1 of the present embodiment, the flexible printed circuit board 28 is fixed to the outer surface of the chassis (case) 12 that houses the cold cathode fluorescent lamps (light source) 20, as shown in FIG. 1. Therefore, in the liquid crystal display device 1 of the present embodiment, the flexible printed circuit board 28 is securely fixed, thereby securing the connection with each of the two printed circuit boards 10. As a result, in the liquid crystal display device 1 of the present embodiment, a plurality of the source drivers 23 can be interconnected more properly. Further, according to the present embodiment, it is possible to configure the liquid crystal display device 1 having a simple structure in which a plurality of the source drivers 23 are properly interconnected when the size of the liquid crystal panel 2 is increased for a larger screen.

Also, in the liquid crystal display device 1 of the present embodiment, the ground wire 28c′ is provided on the flexible printed circuit board 28 and is electrically connected to the chassis 12. As a result, in the liquid crystal display device 1 of the present embodiment, it is possible to easily ground the flexible printed circuit board 28 and the two printed circuit boards 10.

### Embodiment 2

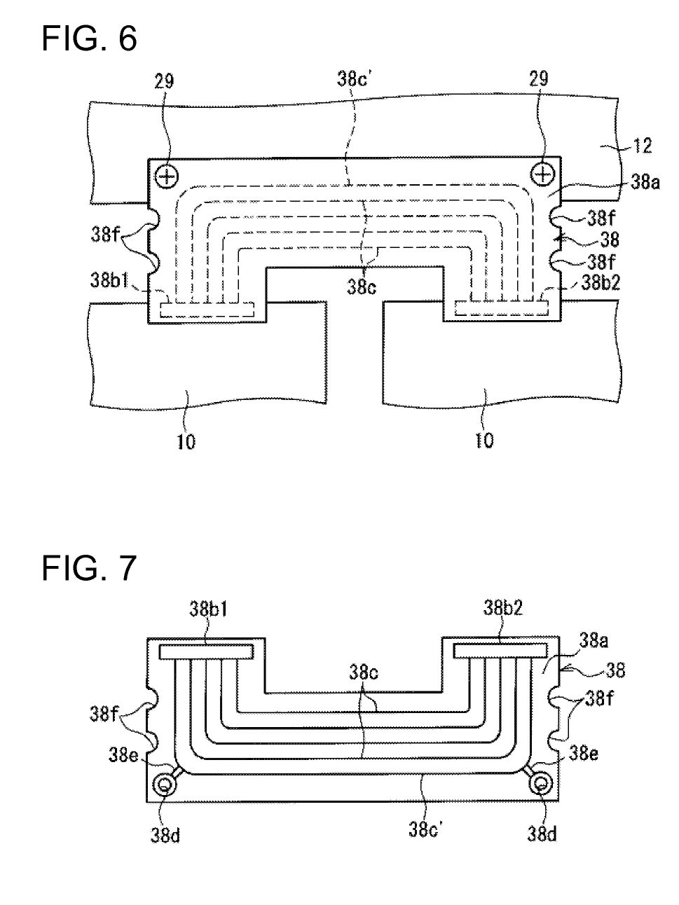

FIG. 6 is an enlarged plan view showing printed circuit boards and a flexible printed circuit board of a liquid crystal display device in a liquid crystal display device according to Embodiment 2 of the present invention. FIG. 7 is an enlarged plan view showing a configuration of a main portion of the flexible printed circuit board shown in FIG. 6. As shown in the figures, a major difference between this embodiment and Embodiment 1 is that in this embodiment slits are formed in the flexible printed circuit board between a connector and a fixing portion to a chassis. Here, components that are shared in common with Embodiment 1 are given the same reference characters, and the redundant descriptions thereof are omitted herein.

That is, as shown in FIGS. 6 and 7, four semicircular slits 38f are formed in a flexible printed circuit board 38 of the present embodiment. Specifically, the flexible printed circuit board 38 includes a substrate body 38a that is bendable; two connectors 38b1 and 38b2 provided on the substrate body 38a; and a plurality of wirings 38c formed in a predetermined pattern on the substrate body 38a so as to connect the connectors 38b1 and 38b2 to each other. The connectors 38b1 and 38b2 are configured to be electrically connected to two adjacent printed circuit boards 10. That is, the connectors 38b1 and 38b2 are configured so as to be linked to connector receptacles (not shown) provided on each of the printed circuit boards 10, and to electrically interconnect the source drivers 23, which are connected respectively to the printed circuit boards 10.

Also, on the flexible printed circuit board 38, a ground wire 38c′ is formed between the connector 38b1 and the connector 38b2 and is configured so as to be electrically connected to a chassis 12. That is, two holes 38d are provided in the flexible printed circuit board 38, and a connecting portion 38e that is connected to the ground wire 38c′ is formed inside and around the holes 38d. And, when a screw 29 is inserted through the hole 38d and the flexible printed circuit board 38 is therefore fixed to the chassis 12 with the screw 29, the ground wire 38c′ is electrically connected to the chassis 12 via the connecting portion 38e and the screw 29, thereby grounding the flexible printed circuit board 38 and the two printed circuit boards 10. Here, the hole 38d and the screw 29 constitute a fixing portion that fixes the flexible printed circuit board 38 to the chassis 12.

Further, two above-described slits 38f are formed at each of the left and right sides of the flexible printed circuit board 38 as shown in FIG. 6. Each of the slits 38f is formed by cutting out a semicircle from a portion of the substrate body 38a between the connectors 38b1 and 38b2 and the holes 38d and the screws 29 used as a fixing portion for fixing to the chassis 12. When the flexible printed circuit board 38 is secured between the two printed circuit boards 10 and the chassis 12, each of the slits 38f accommodates a deformation (twisting) of the substrate body 38a without causing a breakage in the wirings 38c and the ground wire 38c′.

According to the present embodiment having the above-described configuration, it is possible to obtain the similar effects and advantages as in Embodiment 1. Also, according to the present embodiment, since the four slits 38f are formed between the connectors 38b1 and 38b2 and the fixing portions, a twisting that may occur between the connectors 38b1 and 38b2 and the fixing portions in the flexible printed circuit board 38 can therefore be absorbed by the slits 38f, thereby increasing the structural strength in the flexible printed circuit board 38.

It should be understood that the embodiments of the present invention are merely examples and do not limit the present invention. The technical scope of the present invention is indicated by the claims of the present invention and includes all modifications within the scope of the structure and equivalents of the claims herein.

For example, in the above description, a case in which the present invention is applied to a transmissive liquid crystal display device is discussed. However, a display device of the present invention may be any display device configured to include a display unit having a plurality of pixels and capable of displaying information on the display unit. Specifically, the present invention may be applied to various display devices including semi-transmissive type or reflective type liquid crystal display devices, Organic EL (Electronic Luminescence), PDP (Plasma Display Panel), and the like.

Also, in the above description, a configuration in which nine source drivers are each mounted on a flexible printed circuit board (SOF) are provided; three source drivers are connected to a printed circuit board; a flexible printed circuit board is pulled out of a bezel; and two adjacent printed circuit boards are connected to each other via the flexible printed circuit board. However, the present invention shall not be limited in any way as long as a plurality of drivers driving a plurality of pixels provided on the display unit, a plurality of printed circuit boards provided inside the bezel and connected respectively to at least one driver, and a flexible printed circuit board pulled out of the bezel and connected between the two adjacent printed circuit boards are all provided.

Specifically, for example, one possible configuration is that a printed circuit board provided inside a bezel is connected to at least one source driver that is mounted using COG method on an active matrix substrate of a liquid crystal panel, and that such printed circuit boards are connected to each other via a flexible printed circuit board which is pulled out of the bezel. Also, as described above, another possible configuration is that flexible printed circuit boards (SOF) with gate drivers mounted thereon are connected to each other via a flexible printed circuit board which is pulled out of the bezel.

### INDUSTRIAL APPLICABILITY

The present invention is suitable for a display device capable of properly interconnecting a plurality of drivers when the size of a display unit is increased for a larger screen.

### DESCRIPTION OF REFERENCE CHARACTERS

1 liquid crystal display device (display device)
2 liquid crystal panel (display unit)
3 illumination device
10 printed circuit board
12 chassis (case)
14 bezel
20 cold cathode fluorescent lamp (light source)
23 source driver (driver)
28, 38 flexible printed circuit board
28b1, 28b2, 38b1, 38b2 connector
28c′, 38c′ ground wire
28d, 38d hole (fixture)
38f slit
29 screw (fixture)
P pixel

1. A display device that includes a display unit provided with a plurality of pixels to display information on said display unit, comprising:
a bezel housing said display unit;
a plurality of drivers driving said plurality of pixels;
a plurality of printed circuit boards provided inside said bezel and respectively connected to at least one of said drivers; and
a flexible printed circuit board pulled out of said bezel and connected between two adjacent said printed circuit boards.

2. The display device according to claim 1, further comprising a chassis attached to said bezel, wherein said flexible printed circuit board is fixed to an outer surface of said chassis.

3. The display device according to claim 2, further comprising a ground wire on said flexible printed circuit board, wherein said ground wire is electrically connected to said chassis.

4. The display device according to claim 2, further comprising a connector that is electrically connected to said printed circuit board on said flexible printed circuit board, wherein a slit is formed between said connector and a fixing portion to said chassis in said flexible printed circuit board.

5. The display device according to claim 2, wherein said display unit includes a liquid crystal panel, and
wherein said chassis is a case for housing a light source that emits illumination light in an illumination device that irradiates said liquid crystal panel with said illumination light.
